(19) United States
(12) Patent Application Publication
(10) Pub. No.: US 2008/0121056 A1
(43) Pub. Date: May 29, 2008

(54) Ball screw device having silencing device

(75) Inventors: Chien Wei Tsou, Taichung (TW); Yan Yu Chen, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/499,626

(22) Filed: Aug. 3, 2006

(51) Int. Cl. F16H 25/22; F16H 57/04

(52) U.S. Cl. 74/89.44; 74/424.87

(57) ABSTRACT

A ball screw device includes a screw shaft threaded with a ball nut which has one or more channels, and one or more end deflectors attached to the ball nut to form an endless ball rolling passage in the ball nut and to receive a number of bearing members which may facilitate a movement of the ball nut relative to the screw shaft. The ball nut further includes one or more slots communicating with each of the channels, and each for receiving a cushioning member which may cushion the bearing members for reducing a noise that may be generated by the bearing members and the ball nut and the screw shaft. The cushioning member may selectively apply a lubricating material to lubricate the bearing members.

### BACKGROUND OF THE INVENTION

1. Field of the Invention

The present invention relates to a ball screw device, and more particularly to a ball screw device having an inserted cushioning member for engaging with the balls or the bearing members and for cushioning the balls or the bearing members relative to the ball nut and the screw shaft, and for reducing the noises that may be generated by the rotational movement between the balls or the bearing members and the ball nut and the screw shaft, or for silencing purposes, and/or for lubricating purposes.

2. Description of the Prior Art

Typical ball screw devices comprise a ball nut rotatably and/or moveably engaged onto a screw shaft, and normally arranged to allow the ball nut to be rotated and/or moved relative to the screw shaft in great rotational speeds. For allowing the ball nut to be smoothly rotated and moved relative to the screw shaft, a suitable bearing device or lubricating structure is further required to be provided and engaged between the ball nut and the screw shaft, for facilitating the rotational movement between the ball nut and the screw shaft.

For example, U.S. Pat. No. 5,749,266 to Tsukada discloses one of the typical ball screw devices including a number of balls or bearing members provided or engaged into the ball nut and engaged between the ball nut and the screw shaft for facilitating the rotational movement between the ball nut and the screw shaft.

For suitably lubricating the typical ball screw device and for further facilitating the rotational movement between the ball nut and the screw shaft, a coiled lubricating member may further be provided and engaged into the ball nut for contacting or engaging with the balls or bearing members and for lubricating the ball nut and the screw shaft and the balls or bearing members.

However, it will be difficult to dispose or to engage the coiled lubricating member into the ball nut and to be engaged with the screw shaft and the balls or bearing members. In addition, after use, the coiled lubricating member will be compressed and deformed by the balls or bearing members, and the balls or bearing members will thus be loosely received in the endless moving passage that is formed between the ball nut and the screw shaft, and thus will be moved in a snake or wavy shaped moving path relative to the ball nut and the screw shaft, and thus will generate a great noise by the rotational movement between the balls or the bearing members and the ball nut and the screw shaft.

The present invention has arisen to mitigate and/or obviate the afore-described disadvantages of the conventional ball screw devices for such as machine tools or the like.

### SUMMARY OF THE INVENTION

The primary objective of the present invention is to provide a ball screw device including an inserted cushioning member for engaging with the balls or the bearing members and for cushioning the balls or the bearing members relative to the ball nut and the screw shaft, and for reducing the noises that may be generated by the rotational movement between the balls or the bearing members and the ball nut and the screw shaft, or for silencing purposes.

The other objective of the present invention is to provide a ball screw device including an inserted cushioning member for lubricating purposes and for facilitating the rotational movement between the balls or the bearing members and the ball nut and the screw shaft.

In accordance with one aspect of the invention, there is provided a ball screw device comprising a ball nut including a bore formed therein and having an inner thread formed therein and defined by a number of helical groove portions, the ball nut including at least one depression formed therein and communicating with the bore thereof, the ball nut including at least one channel formed therein and communicating with the depression thereof, and the ball nut including at least one slot formed therein and communicating with the channel thereof, a screw shaft rotatably engaged into the bore of the ball nut, and including an outer thread formed thereon and defined by a number of helical groove portions for threading with the inner thread of the ball nut and for allowing the ball nut to be rotated and moved relative to the screw shaft, at least one end deflector engaged into the depression of the ball nut, and including a curved pathway formed therein for communicating with the channel of the ball nut and for forming an endless ball rolling passage in the ball nut, a number of bearing members engaged in the endless ball rolling passage in the ball nut for engaging between the ball nut and the screw shaft and for facilitating a movement of the ball nut relative to the screw shaft, and at least one cushioning member engaged in the slot of the ball nut for engaging with the bearing members and for cushioning the bearing members and for reducing a noise that may be generated by a rotational movement between the bearing members and the ball nut and the screw shaft.

The cushioning member includes at least one tapered end for forming a relatively enlarged end portion of the channel of the ball nut and for allowing the bearing members to be easily engaged into the channel of the ball nut.

The ball nut includes at least one second slot formed therein and communicating with the channel thereof. The slot and the second slot of the ball nut are equally spaced from each other.

The cushioning member may include a circular cross section, or a non-circular cross section, such as a square cross section, a rectangular cross section, or the like.

The cushioning member may also be used to selectively apply a lubricating material into the endless ball rolling passage of the ball nut for further facilitating the rotational movement between the bearing members and the ball nut and the screw shaft.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a ball screw device in accordance with the present invention;

FIG. 2 is another partial exploded view of the ball screw device;

FIG. 3 is an enlarged partial perspective view of the ball screw device;

FIG. 4 is an enlarged partial cross sectional view of the ball screw device, taken along lines 4-4 of FIG. 5;

FIG. 5 is another enlarged partial cross sectional view taken along lines 5-5 of FIG. 4;

FIG. 6 is an enlarged partial cross sectional view similar to FIG. 4, taken along lines 6-6 of FIG. 7, illustrating the other arrangement of the ball screw device;

FIG. 7 is a further enlarged partial cross sectional view taken along lines 7-7 of FIG. 6;

FIG. 8 is a still further enlarged partial cross sectional view similar to FIGS. 4 and 6, illustrating the further arrangement of the ball screw device;

FIG. 9 is a still further enlarged partial cross sectional view similar to FIGS. 4, 6 and 8, illustrating the still further arrangement of the ball screw device; and

FIG. 10 is a still further enlarged partial cross sectional view similar to FIGS. 4, 6, 8 and 9, illustrating the still further arrangement of the ball screw device.

### DETAILED DESCRIPTION OF THE PREFERRED EMBODIMENT

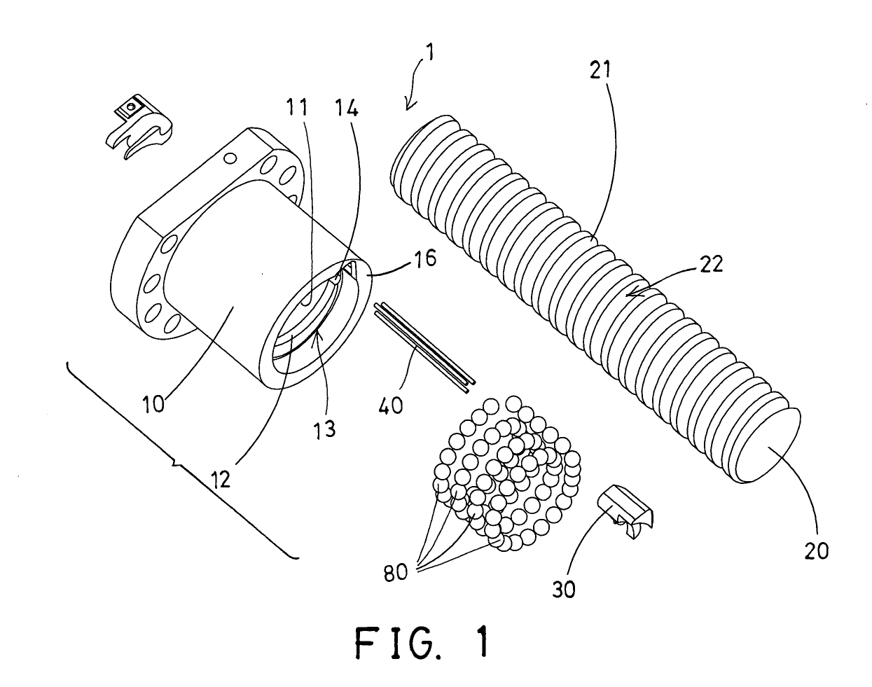

Referring to the drawings, and initially to FIGS. 1-5, a ball screw device 1 in accordance with the present invention comprises an outer ball nut 10 including a bore 11 formed therein and having an inner thread 12 formed therein and defined by a number of peripheral and helical groove portions 13 for threading with an outer thread 21 of a screw shaft 20 (FIG. 1), and thus for allowing the ball nut 10 to be moved along the screw shaft 20, or for allowing the screw shaft 20 to be rotated and moved relative to the ball nut 10.

The screw shaft 20 also includes a number of peripheral and helical groove portions 22 formed therein for forming or defining the outer thread 21 thereof, and for forming a multiple turn, helical raceway and for rotatably and/or movably receiving one or more groups of balls or rollers or rolling or ball bearing members 80 therein which may facilitate the rotating movement of the ball nut 10 relative to the screw shaft 20 when the screw shaft 20 is forced to rotate relative to the ball nut 10 or when the ball nut 10 is forced to rotate relative to the screw shaft 20, in order to constitute the primary structure of the ball screw device 1.

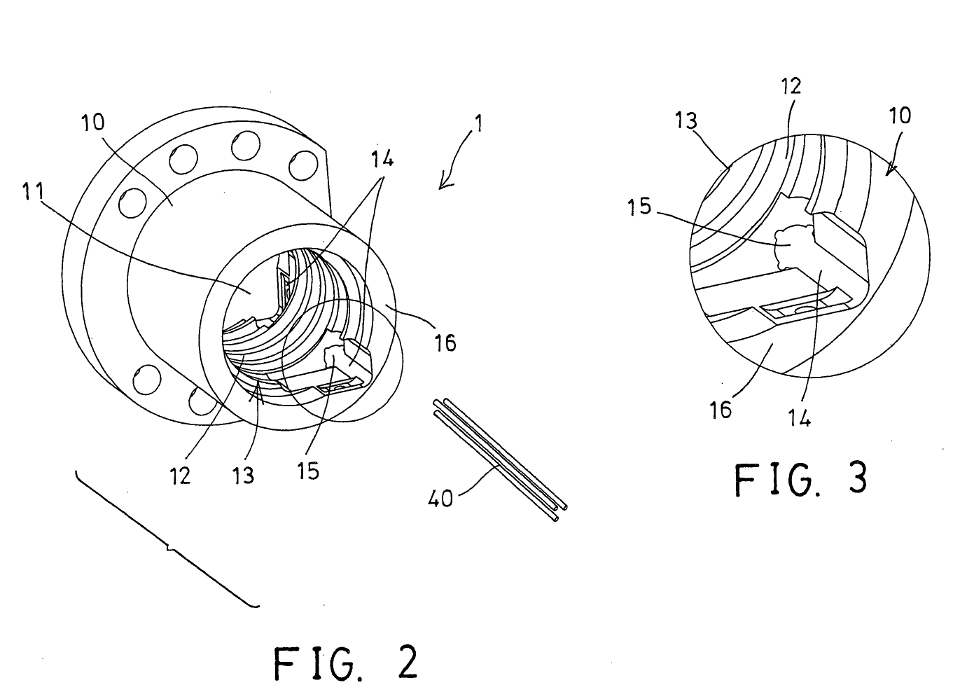

The ball nut 10 includes one or more, such as two depressions 14 formed therein (FIGS. 1-3) each for receiving an end deflector 30 therein (FIGS. 1, 5, 7), one example of the end deflectors 30 has been disclosed in a co-pending U.S. patent application Ser. No. 11/291,691, filed 1 Dec. 2005, which may be taken as a reference for the present invention. The ball nut 10 further includes one or more channels 15 formed therein (FIGS. 2-10), such as longitudinally formed in the outer peripheral wall 16 of the ball nut 10 and communicating with the depressions 14 thereof (FIGS. 2-3) for forming and representing an endless ball rolling passage 88 and for rotatably and/or movably receiving the balls or rollers or rolling or ball bearing members 80 therein.

The end deflectors 30 each may include a curved pathway 31 formed therein (FIGS. 5, 7) for communicating with the channel 15 of the ball nut 10 and for communicating with the helical groove portions 13 or the inner thread 12 of the ball nut 10 for guiding the ball bearing members 80 to move into or out of the channel 15 of the ball nut 10 and thus for forming the end portions of the endless ball rolling passage 88. The end deflectors 30 may also be replaced with such as end caps (not shown) which may be attached to the ball nut 10 and which are not related to the present invention and will not be described in further details.

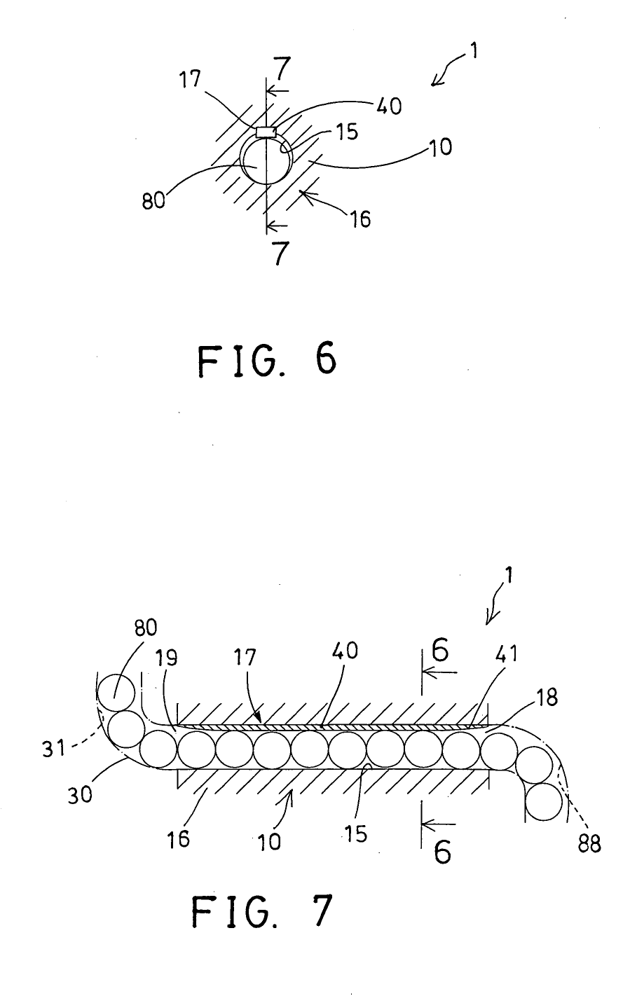

The ball nut 10 further includes one (FIGS. 6, 7), two (FIG. 10) or more (FIGS. 1-5, and 8-9) longitudinal slots 17 formed therein with such as cutting or milling operations, and communicating with each of the channel 15 of the ball nut 10, and each for engaging or receiving a cushioning member 40 therein. The cushioning members 40 are made of rubber, plastic, or other synthetic or compound materials for resiliently engaging with the cushioning members 40 and for cushioning the balls or bearing members 80 relative to the ball nut 10 and the screw shaft 20, and for reducing the noises that may be generated by the rotational movement between the balls or bearing members 80 and the ball nut 10 and the screw shaft 20, or for silencing purposes.

The cushioning members 40 may also be provided for lubricating purposes and/or for selectively applying lubricating materials into the endless ball rolling passage 88 that is formed in or between the ball nut 10 and the screw shaft 20 and thus for further facilitating the rotational movement between the balls or bearing members 80 and the ball nut 10 and the screw shaft 20. It is preferable that the cushioning members 40 each includes one or two tapered or reduced or inclined ends 41 (FIGS. 5, 7) for forming or defining two relatively enlarged end portions 18, 19 of each of the channel 15 of the ball nut 10, and thus for allowing the balls or bearing members 80 to be easily engaged into the channels 15 of the ball nut 10.

It is to be noted that the cushioning members 40 are engaged in the longitudinal slots 17 that are formed in the outer peripheral wall 16 of the ball nut 10 and communicating with the channels 15 of the ball nut 10, for allowing the longitudinal slots 17 to be easily formed or machined with the outer peripheral wall 16 of the ball nut 10, and for allowing the cushioning member 40 to be easily and quickly engaged into the longitudinal slots 17 of the ball nut 10, and for allowing the cushioning member 40 to be directly engaged with the balls or bearing members 80 and to reduce the noises that may be generated by the rotational movement between the rotational movement between the balls or bearing members 80 and the ball nut 10 and the screw shaft 20.

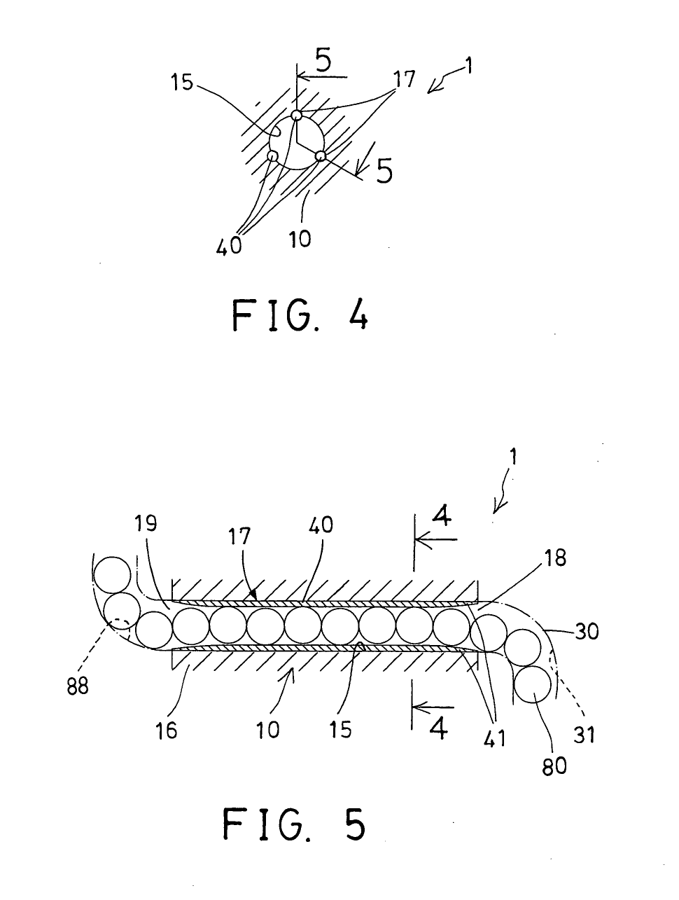

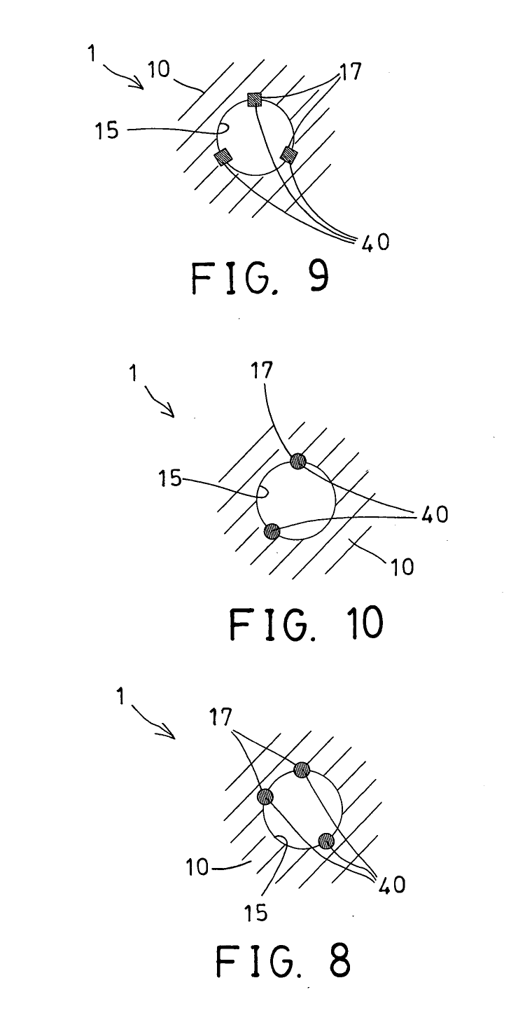

As shown in FIGS. 4, 5, the cushioning members 40 include a circular cross section, and are preferably equally spaced from each other for evenly engaging with the balls or bearing members 80. Alternatively, as shown in FIGS. 8 and 10, the cushioning members 40 may also be randomly spaced from each other for different spacing distances or different spacing angles. As shown in FIG. 9, the cushioning members 40 may also include a non-circular cross section that is different from the circular cross section, such as the square cross section, rectangular cross section (FIG. 6) or other cross sections.

Accordingly, the ball screw device in accordance with the present invention includes an inserted cushioning member for engaging with the balls or the bearing members and for cushioning the balls or the bearing members relative to the ball nut and the screw shaft, and for reducing the noises that may be generated by the rotational movement between the balls or the bearing members and the ball nut and the screw shaft, or for silencing purposes, and/or for lubricating purposes and for facilitating the rotational movement between the balls or the bearing members and the ball nut and the screw shaft.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ball screw device comprising:
a ball nut including a bore formed therein, and including an inner thread formed in said bore thereof and defined by a plurality of helical groove portions, said ball nut including at least one depression formed therein and communicating with said bore thereof, said ball nut including at least one channel formed therein and communicating with said at least one depression thereof, and said ball nut including at least one slot formed therein and communicating with said at least one channel thereof,
a screw shaft rotatably engaged into said bore of said ball nut, and including an outer thread formed thereon and defined by a plurality of helical groove portions for threading with said inner thread of said ball nut and for allowing said ball nut to be rotated and moved relative to said screw shaft,
at least one end deflector engaged into said at least one depression of said ball nut, and including a curved pathway formed therein for communicating with said at least one channel of said ball nut and said helical groove portions of said inner thread of said ball nut, and for forming an endless ball rolling passage in said ball nut,
a plurality of bearing members engaged in said endless ball rolling passage in said ball nut for engaging between said ball nut and said screw shaft and for facilitating a movement of said ball nut relative to said screw shaft, and
at least one cushioning member engaged in said at least one slot of said ball nut for engaging with said bearing members and for cushioning said bearing members and for reducing a noise that may be generated by a rotational movement between said bearing members and said ball nut and said screw shaft.

2. The ball screw device as claimed in claim 1, wherein said at least one cushioning member includes at least one tapered end for forming a relatively enlarged end portion of said at least one channel of said ball nut and for allowing said bearing members to be easily engaged into said at least one channel of said ball nut.

3. The ball screw device as claimed in claim 1, wherein said ball nut includes at least one second slot formed therein and communicating with said at least one channel thereof.

4. The ball screw device as claimed in claim 3, wherein said at least one slot and said at least one second slot of said ball nut are equally spaced from each other.

5. The ball screw device as claimed in claim 1, wherein said at least one cushioning member includes a circular cross section.

6. The ball screw device as claimed in claim 1, wherein said at least one cushioning member includes a square cross section.

7. The ball screw device as claimed in claim 1, wherein said at least one cushioning member includes a rectangular cross section.

8. The ball screw device as claimed in claim 1, wherein said at least one cushioning member selectively applies a lubricating material into said endless ball rolling passage in said ball nut.
